(19) United States
(12) Patent Application Publication
(10) Pub. No.: US 2002/0077844 A1
(43) Pub. Date: Jun. 20, 2002

(54) Component-description-manual creation support method, component-description-manual creation support system, and computer-readable recording medium

(75) Inventor: Kanji Hayashi, Nagoya (JP)

Correspondence Address: Ronald R. Snider, Snider & Associates, P.O. Box 27613, Washington, DC, 20038-7613, US

(73) Assignee: CMC Corporation, Nagoya (JP)

(21) Appl. No.: 09/984,655

(22) Filed: Oct. 30, 2001

(30) Foreign Application Priority Data
Oct. 31, 2000 (JP) 2000-333703

(51) Int. Cl. G06F 17/60

(52) U.S. Cl. 705/1

(57) ABSTRACT

Methods to be provided include a method capable of correctly listing information to be described in manual according to specifications of products and capable of easily handling tasks involved in, for example, design changes; and a method of easily retrieving a most-suitable existing manuscript that is to be diverted without depending on experiences or the like of manuscript-creating person, thereby enabling a plurality of manuscript-creating person to effectively use the existing manuscript. To create a manual of a product, per-item index data is determined according to a specification of the product. The items are determined in units of, for example, a chapter, a paragraph, or a component (of the product) of the manual. On the other hand, retrieval is performed from a manuscript database for a manuscript as a diversion source corresponding to the index data. Then, the retrieval result is displayed on a display screen as manuscript data of the manual in a state where the per-item index data and relevant per-group manuscript data corresponds to each other. To perform correction of the manuscript data of the manual, the correction may be performed through the display screen by inputting correction data. However, if no correction is needed, the data, as it is, may be determined to be manuscript data of the manual.

### RELATED APPLICATION

This application claims the priority of Japanese Patent Application NO. 2000-333703 filed on Oct. 31, 2000, which is incorporated herein by reference.

### BACKGROUND OF THE INVENTION

1. Field of the Invention

The present invention relates to a product-description-manuscript using method, a component-description-manual creation support method, a component-description-manual creation support system, and a computer-readable recording medium containing program for implementing the component-description-manual creation support method.

2. Related Art

In many cases, it is advantageous to divert or reference portions of an existing manual to create a new product-component description manual. An ordinary method is carried out such that, for example, reference, addition, partial changes, and the like are made using an existing manuscript of a manual, and the resultant portions are incorporated into portions of a new manuscript of a manual in creation.

However, finding appropriate portions to be diverted and/or referenced from existing manuals greatly depends on the memory and the experience of a manual-creating person, and there occur significant differences in results achieved by an experienced person and a less-experienced person. Consequently, variations occur in the determination of most-suitable diversion sources and in work efficiency. In addition, in conventional methods, existing manuscript pages to be diverted and/or referenced are copied on a paper basis; and a manuscript-creating person performs, for example, correction in red on the paper copies. Hence, a huge amount of paper resource is used, and a dedicated DTP operator is necessary for changing data of the red-written correction into DTP data.

In the conventional method, documents, such as specifications regarding a product that is an object of the manual creation, are first collected. Thereafter, the documents are referenced, and usable specifications regarding the product are determined according to destinations and grades of the product. According to the product specifications, information is arranged for creating a manuscript for a manual, and contents to be comprehended in the manual are determined. These tasks are also carried out on a paper basis. This method requires the manual-creating person to have a special knowledge for reading the contents of the documents and for understating the relationships among a plurality of the documents. When these relationships are complicated, the manual-creating person is apt to overlook to fully include contents required in the manual. Furthermore, when the product is changed in, for example, design, after the arrangement of information and the determination of contents of the manual, it is difficult to clarify tasks required for reflecting the changes in the manual and prolongs the time for creating the manual.

### SUMMARY OF THE INVENTION

The present invention is made to solve the above-described problems. A primary object of the present invention is to provide a method that enables information required for a manual to be correctly comprehended and that enables tasks corresponding to design changes and the like to easily be achieved, and a method that enables most-suitable existing data for diversion and reference to easily be found without relying on the experience and the memory of a manual-creating person and that enables the existing data to effectively be used among a plurality of manuscript-creating persons. Still other objects of the present invention are to provide a system that enables the aforementioned methods to suitably be executed, and a computer-readable program therefor.

To achieve the above objects, the present invention provides a method for creation of a component description manual such as an instruction manual or a repair manual for individual components of a unit product formed as an assembly of many components for an automobile or the like, wherein text, drawing, image, and other component-description data in the component-description manual created in the past for each of the components is stored in a storing means in a form including text data that constitutes text of the component description manual, and summary data that summarizes characteristics of the individual components, and in a retrievable form including retrieval terms with which the aforementioned individual component-description data can individually be retrieved.

When newly creating a component description manual of a specific component, according to an input of retrieval terms such as an article number, a name, a characteristic, and the like of a component that is similar to or identical to the specific component, only summary data is retrieved from an aggregate of the aforementioned component-description data stored, and description data regarding the specific component corresponding to the summary data is retrieved from the aforementioned storing means.

In addition, when applicable component-description data has been retrieved, the component-description data is copied by a data-creating means, and the component-description data is either diverted as copied or is appropriately edited, thereby making the aforementioned component-description data to be creation-object component-description data; when no applicable component-description data has been retrieved, component-description data of the specific component is newly written, thereby making the aforementioned component-description data to be creation-object component-description data; and either the aforementioned newly written component-description data or both the aforementioned newly written component-description data and the aforementioned edited component-description data are stored in the aforementioned storing means in the aforementioned retrievable form as component-description data for creation of a subsequent component description manual so as to be accumulatively stored as a database. Thus, retrieving only summary data of each component can make time required for retrieving entire text significantly reduced.

In the above, the arrangement may be made as follows. The summary data is composed of character data composed mainly in a second language that is different from a language(*) used as a standard of character data to compose the manuscript data (*: the language hereinbelow will also referred to as a “manuscript-data standard language”). According to an input of retrieval terms in the aforementioned second language, retrieval access is made to individual summary data in individual per-group description data, and readout is carried out for per-group description data corresponding to the summary data composed to include a character string that is identical or similar to the retrieval-character-string data.

According to the above arrangement made such that the language used as a standard of the manual is different from the language used for the summary data, significantly advantages can be obtained, for example, in creating databases of manuscript data of a foreign language as well as in retrieval of the manuscript data. The language used as a standard for a manual refers to a language mainly used to compose text data excluding summary data in the component-description data.

In practice, for example, the above-described arrangement may be made such that a language other than the Japanese language is used as the manual standard language, and the Japanese language is used as a second language. This arrangement is significantly advantageous in the case where a Japanese retrieving person attempts to retrieve manuscript data composed mainly in one of various foreign languages other than the Japanese language, such as the English language, the French language, the German language, or the Spanish language.

In more specific, even in a case where a retrieval condition is input using the Japanese language, manuscript data in a foreign language can easily be retrieved, and the retrieval condition need not be translated to the target foreign language by the retrieving person. This enables the retrieval efficiency to significantly increase not only in the case of a retrieving person who is not familiar to foreign languages, but also in the case of a retrieving person who is familiar to foreign languages.

The component description manual includes any one of documents describing a product in units of a component. The documents include those describing per-component functions of a product, a per-component use method, cautions and notices regarding a component, and descriptions regarding other products.

### BRIEF DESCRIPTION OF THE DRAWINGS

FIG. 1 is a schematic block diagram showing a manual creation system of the present invention;

FIG. 2 is a schematic block diagram showing an example configuration of a terminal;

FIG. 3 is a view showing a manual creation system of the present invention that is configured of a single computer;

FIG. 4 is an explanatory view conceptually showing an example data structure of a database;

FIG. 5 is an explanatory view conceptually showing an example data structure of a specification database;

FIG. 6 is an explanatory view conceptually showing a part of a configuration of the present invention;

FIG. 7 is a flowchart showing an example flow of specification-data retrieval processing;

FIG. 8 is a flowchart showing another example flow of specification-data retrieval processing;

FIG. 9 is a flowchart conceptually showing a configuration continued from configuration shown in FIG. 6;

FIG. 10 is a flowchart showing an example flow of manuscript-data retrieval processing;

FIG. 11 is a flowchart showing another example flow of the processing shown in FIG. 10;

FIG. 12 is a view showing an example structure of index data;

FIG. 13 is a continued view of FIG. 12;

FIG. 14 is view showing a practical example of component-description data;

FIG. 15 is a view showing an example structure of per-product manuscript data;

FIG. 16 is a flowchart showing a detailed example of the structure shown in FIG. 15;

FIG. 17 is a flowchart showing a detailed example of the structure shown in FIG. 16;

FIG. 18 is a view showing an example portion of manuscript data; and

FIG. 19 is a view showing another example configuration of per-product manuscript data.

### DESCRIPTION OF THE PREFERRED EMBODIMENTS

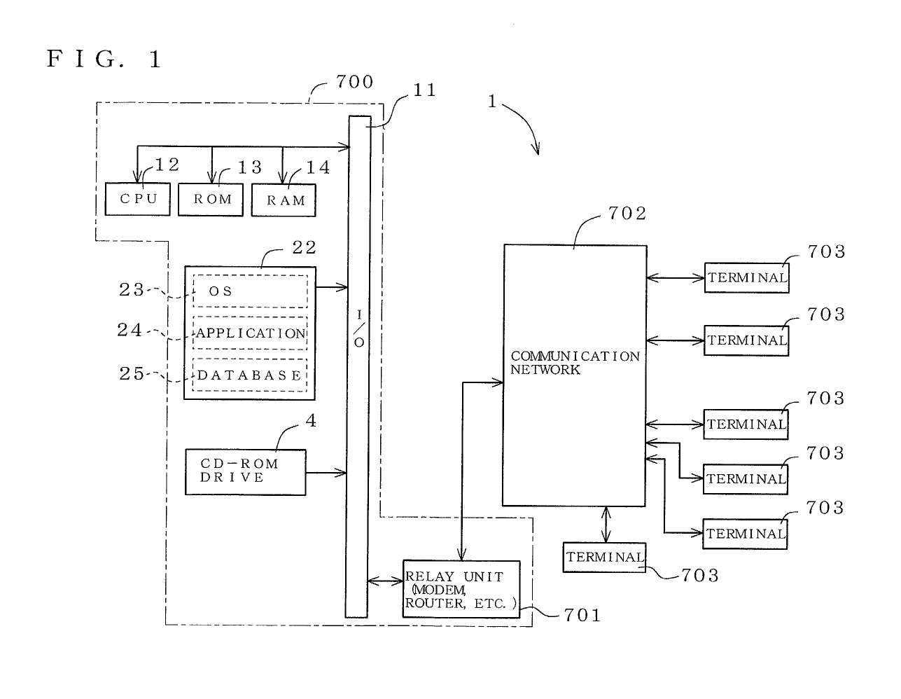

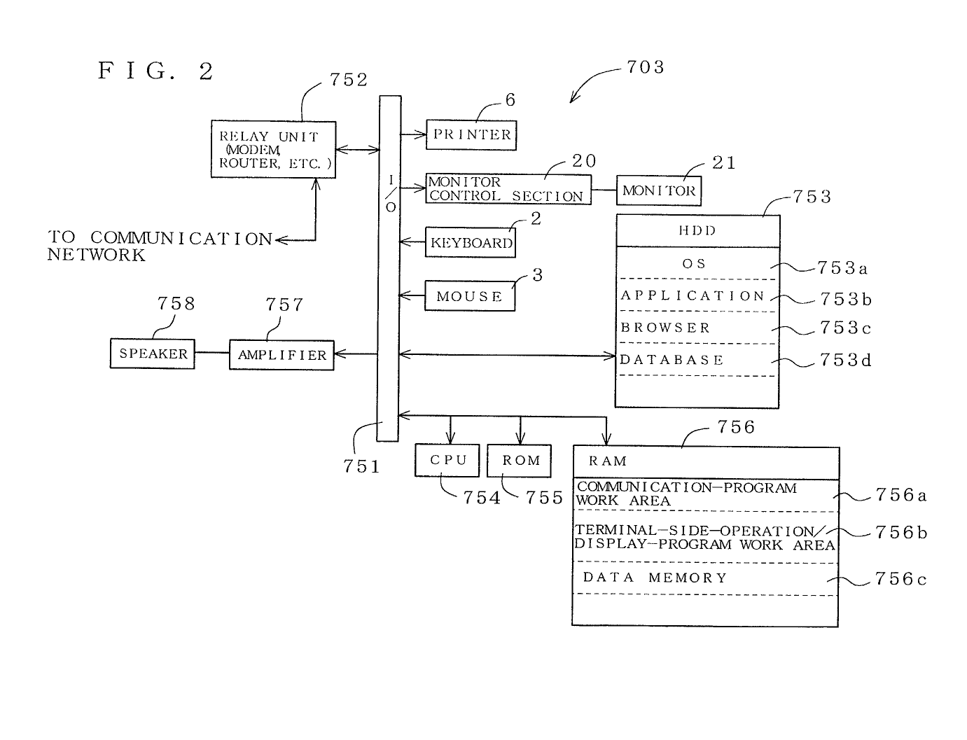

Hereinbelow, embodiments of the present invention will be described with reference to the accompanying drawings. FIG. 1 is a block diagram showing a configuration of a manual creation system1 (which hereinbelow will often be referred to as a “system”). The system 1 is configured to include a communication network 702 such as the Internet, a host unit 700, and a plurality of terminal units 703 (each of which hereinbelow will often be referred to either a “terminal 703” or an “electronic terminal”). The host unit 700 is connected to the communication network 702 via a relay unit 701 (such as a modem and router) provided as a transmitting-receiving means. Each of a plurality of terminals 703 is connected to the communication network 702 respectively via a relay unit 752 ((shown in FIG. 2) such as a modem or router) which is provided as a transmitting-receiving means.

The host unit 700 is configured as a computer including an I/O port11. A CPU 12, a fixed storage unit 22 configured to include a hard-disk drive, a ROM 13, a RAM 14, and a CD-ROM drive 4 and the like are connected to the I/O port 11. (The I/O port 11 may additionally be connected to output units such as a monitor and a printer, input devices such as a keyboard and a mouse, a calendar clock, and the like). The fixed storage unit 22 contains an application program 24 (which hereinbelow will often be referred to as an “application”) that implements functions of the manual creation system1 with the computer, an operating system program 23 (OS) for forming an operation environment therefor, and a database 25 used in various steps of the manual creation.

The aforementioned programs 23 and 24 and the database 25 are stored in a recording medium, such as a CD-ROM (or another portable recording medium, such as a DVD), and is supplied in that form. The recording medium is set onto CD-ROM drive 4 provided as a reading unit, and specified install program (not shown) is driven By CPU 12. Thereby, the programs 23 and 24 and the database 25 can be installed into the fixed storage unit 22. In this case, the configuration may be arranged such that the install program is distributed from a different server connected to the host unit 700 via the communication network. The ROM 13 contains various basic programs used for controlling hardware of the computer. In addition, the RAM 14 includes work areas used to execute the various programs stored in the fixed storage unit 22 and the ROM 13.

As shown in FIG. 2, each of the terminals 703 is configured as a computer including an I/O port 751; and it also has a CPU 754, a ROM 755, and a RAM 756 that are connected to the I/O port 751. In addition, the I/O port 751 is connected to a keyboard 2 and a mouse 3 (which may be replaced by a different pointing device) that are provided as input means, and a printer6 including a printer control section (not shown) and a monitor control section 20 that are provided as output means. The monitor control section 20 is connected to a monitor 21 provided as an output means including a display screen. For the terminals 703, various types of computers may be used including desktop type. The usable computers include notebook personal computers each using a battery as a power source, and laptop personal computers, palmtop computers (PDAs).

From the above-described terminal 703 connected to the system via the communication network 702, a user inputs information (data) necessary for individual operations (such as a manuscript-retrieval request condition, a specification-retrieval request condition). A predetermined communication program executes communication on the side of the terminals 703. The execution uses a communication-program work area 756a in the RAM 756 shown in FIG. 2. The information (such as a manuscript-retrieval request condition or a specification-retrieval request condition) that has been input using the mouse 3 or the keyboard 2 from the terminal 703 is transmitted to the host unit 700 through the communication network 702. Then, the application program 24 executes various steps of processing. The processing result (such as manuscript data or specification data) is transmitted via the communication network 702 to the accessed terminal 703. Then, the resultant data is output to the printer 6 or the monitor 21 that are connected to the accessed terminal 703. The configuration may be arranged such that, together with visual information sent from a monitor or the like, audio data is output through a speaker 758 coupled to the I/O port 751 via an amplifier 757. Specifically, a terminal-side operation/display program that forms an operation/display screen on the monitor 21 of the terminal 703 through a graphic user interface (GUI) is sent to the terminal 703 from the host unit 700, and the program is executed using the work area 756a and a work area 756b. In addition, the terminal 703 includes a hard-disk drive 753 (which hereinbelow will often be referred to as an “HDD”) as a fixed storage unit. The hard-disk drive 753 contains, for example, an operating system 753a that manages the terminal 703, and a browser 753c that serves for access from the terminal 703 to the host unit 700 via the Internet. In addition, the HDD 753 contains a database753d and an application 753b. The database 753d is used to store various types of data downloaded from the host unit 700, and the application 753b executes various processing steps for manual creation that is performed with the terminal 703. Data such as manuscript data from the host unit 700 is stored into a data memory 756c (the data may instead be stored into the database 753d).

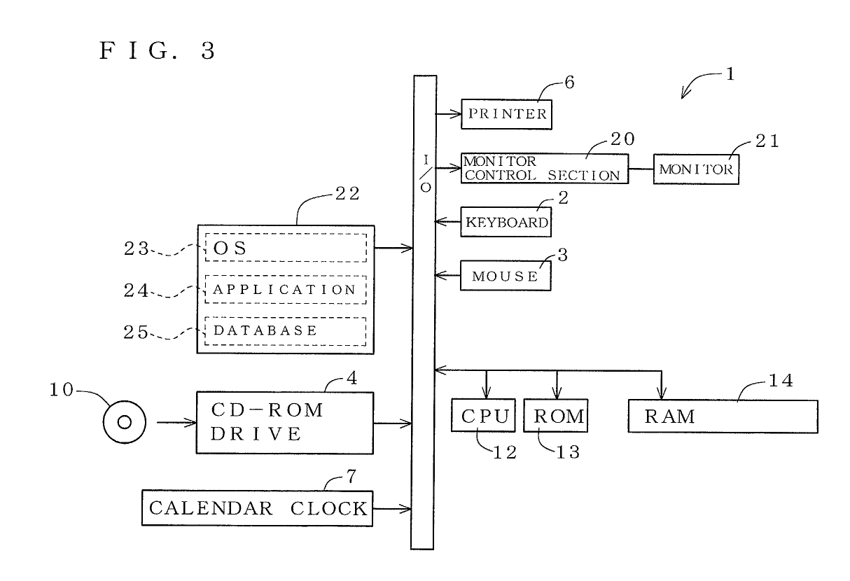

As a matter of course, the manual creation system 1 of the present invention may be configured of a single computer, as shown in FIG. 3. In this case, the application program for implementing the functions of the system of the present invention is supplied in the form of being stored in a recording medium such as a CD-ROM 10. The application program can be installed in the computer by using a reading unit such as a CD-ROM drive 4. Alternatively, the configuration may be modified such that the application program is downloaded to install to the computer connected to the communication network from a different distribution computer connected to the communication network.

Referring back to FIG. 1, the application program 24 of the host unit 700 plays the role of implementing individual system portions on the OS 23 as the following means as stated in the appended claims:

CPU 12: a retrieval means or a data-creating means

Fixed storage unit 22: a storing means or a data-accumulating means.

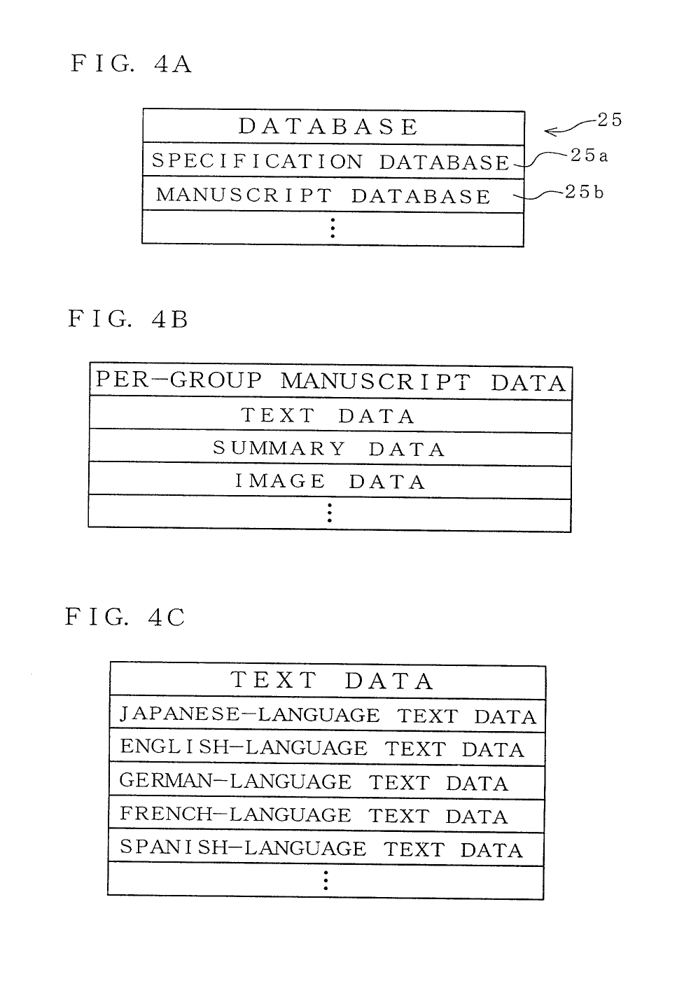

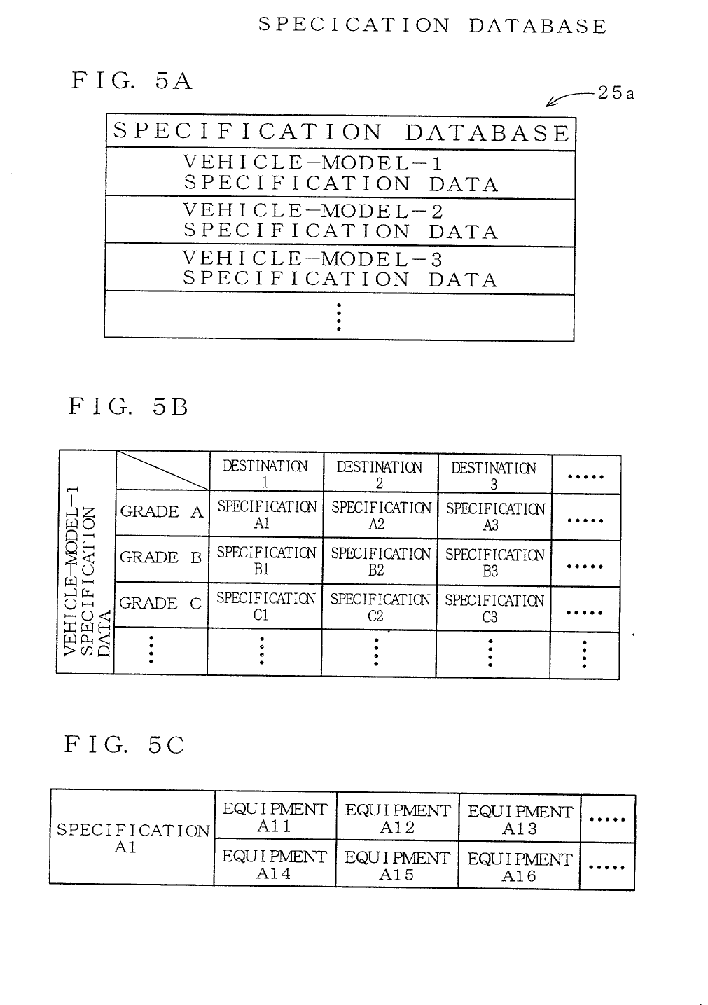

Hereinbelow, database configurations will be described. FIGS. 4 and 5A to 5C each show an example database configuration that implements the present invention. As shown in FIG. 4A, the database of the present invention is configured to include a specification database 25a that is used to store product specification data. The specification data has a data structure that allows the setting of index data of items that are to be described in the manual for each destination of products and in units of a product-specification type such as the grade. For example, the database may be configured as shown in FIGS. 5A to 5C. However, the data structure is not limited to the configurations shown in the figures.

FIGS. 5A to 5C show a case in which the objects are vehicles. As shown in FIG. 5A, in the specification database 25a, the specification data is discretely set in units of a vehicle model in a plurality of vehicle models. As in the case shown in FIG. 5B for vehicle-model-1 specification data, for each of the vehicle models, multi-setting can be done for destination such as a specific destination area (such as North America or Europe), a specific destination nation (such as England or Germany), and the grade and the like. In the above, the component type, the number of components, and the like that are to be equipped are different for each of the destinations or each of the grades. The settable specification types are not limited to the destination and the grade, and include various other specifications. For example, the arrangement may be made such that a body-shape specification, a transmission specification, and an engine specification and others are made to be settable condition as the specification type. In this way, the individual specification types are set to enable the determination of items to be described in an intended manual.

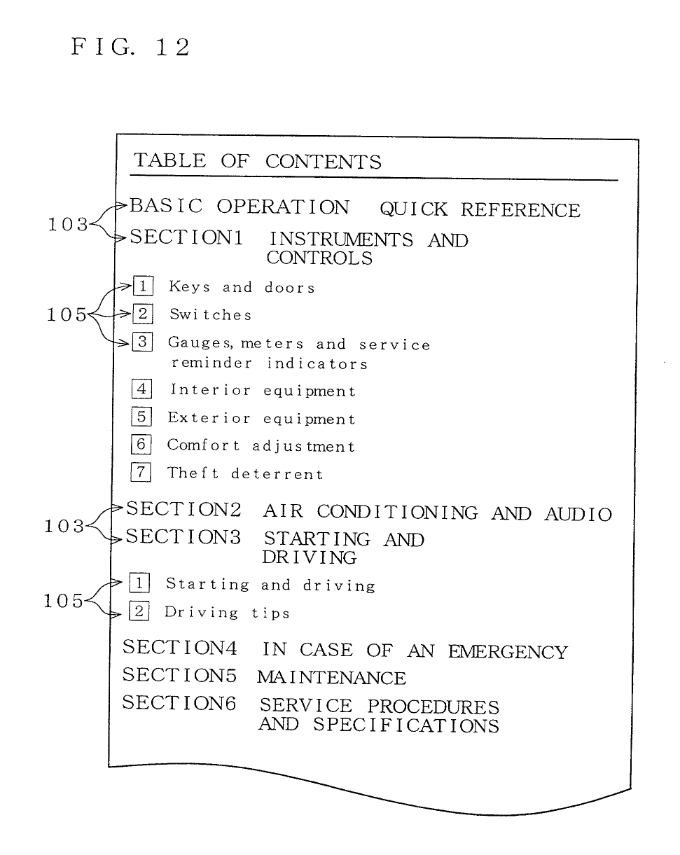

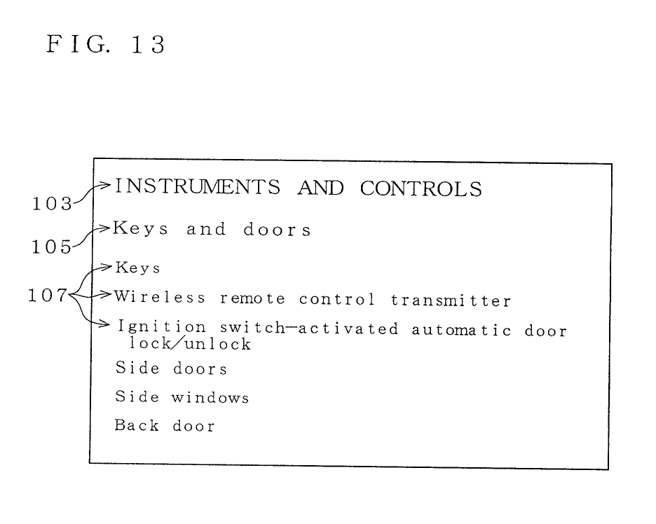

For example, in FIG. 5B, when the destination1 and the grade A are designated, specification data (specification A1) corresponding (specifically, in one-to-one correspondence) to the designated specification types is selected. Other specification types (such as a body-shape specification, a transmission specification, and an engine specification) may be made to be an equipment-determination condition. In addition, as shown in FIG. 5C, the specification data is configured such that equipment index data indicating required types of equipment is discretely set in units of the specification type. In this case, when the specification data is determined, equipment to be described in the manual is determined in one-to-one correspondence to the determined specification data. The equipment index data can be configured as shown in FIGS. 12 and 13 for example. FIG. 12 shows an example display screen of equipment index data. The display screen includes indexes in a plurality of sections (per-section indexes 103), such as those named “INSTRUMENTS AND CONTROLS” and “AIRCONDITIONING AND AUDIO”. In addition, each of the sections includes per-relevant-component indexes 105, such as “Keys and doors” and “Switches”, that are provided in units of a relevant component. Moreover, as shown in FIG. 13, the data may be structured to have per-component indexes 107, such as “Keys” and “Wireless remote control transmitter”, so as to be dependent on the per-relevant-component index 105. The specification database containing the specification data, which enables the above-described data structure to be realized, is used in specification-data retrieval processing performed for determining a manual configuration. Hereinbelow, the specification-data retrieval processing will be described.

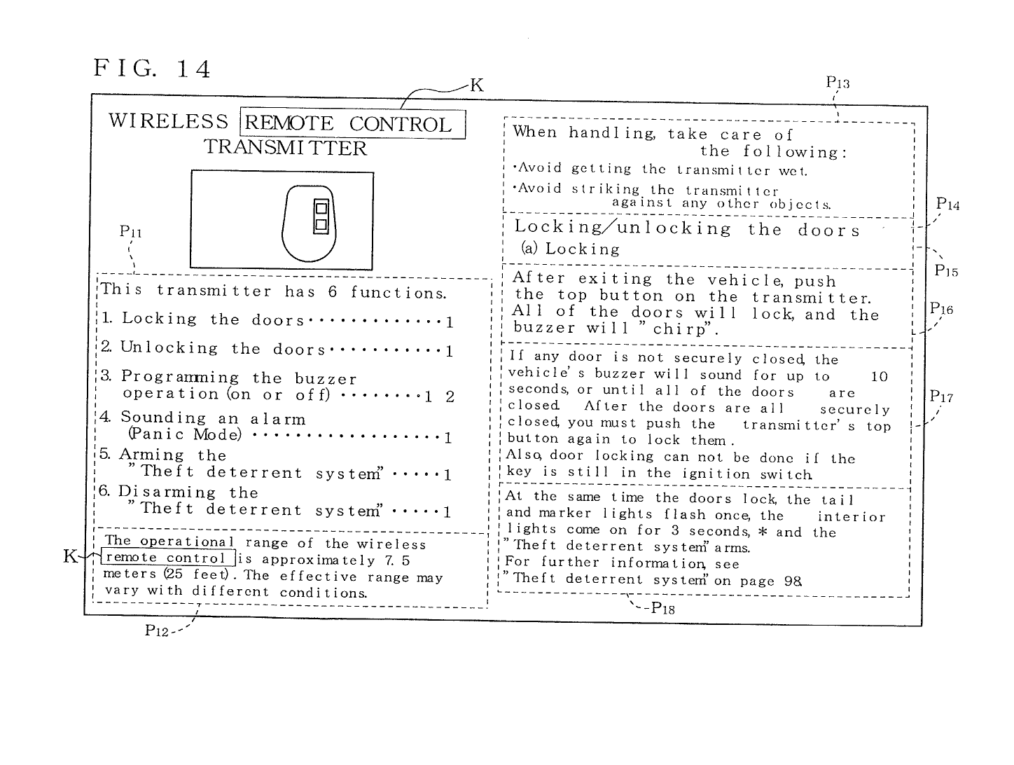

First, a method of creating a manual (component description manual) will be outlined hereinbelow. In the method of the invention, for creating a component description manual, such as an instruction manual or a repair manual, regarding individual components of a unit product configured into an assembly of multiple components of an automobile or the like, per-component description data of text, drawings, images, and the like contained in component description manuals created in the past is stored in a form including retrieval terms that can be used to retrieve individual component-description data. When creating a specific component description manual, instead of newly writing the component description manual from the beginning (to reduce the labor of newly writing a component description manual), items such as an article number, a name, characteristics, and other component retrieval terms of a component that is identical or similar to an object component are input into the system. In response to the entry of the items, retrieval is performed for description data regarding the specified object component from an aggregate of the stored component-description data. If applicable data has been retrieved, the retrieved data is copied, and the data as copied is diverted, or the data is appropriately edited. In this manner, the data is used as manual-creation-object component-description data. On the other hand, if no data has been retrieved, description data of the specified object components is newly written, the newly written component-description data or both of the newly written component-description data and the edited component-description data is stored in the retrievable form as the component-description data for creation of a subsequent component description manual in the future. Further, the data is accumulated as a database. For example, in an event the component-description data as shown in FIG. 14 has been retrieved as the relevant component-description data, when the data as retrieved is to be diverted, the data is used as manuscript data for the component description manual that is to be newly created. When modification, addition, and the like are to be carried out, character input operations are performed on the display screen as shown in FIG. 14, thereby enabling the data partially corrected or to be newly written. When the above described method is employed, a manuscript to be diverted can be quickly retrieved to create a component description manual, and concurrently, the manuscript creation can readily be started using the display screen using the retrieved manuscript. In addition, when the created manuscript data of the component description manual is stored and registered again as component-description data into a database (manuscript database), the created manuscript data can be used to create a manual (component description manual) in the future.

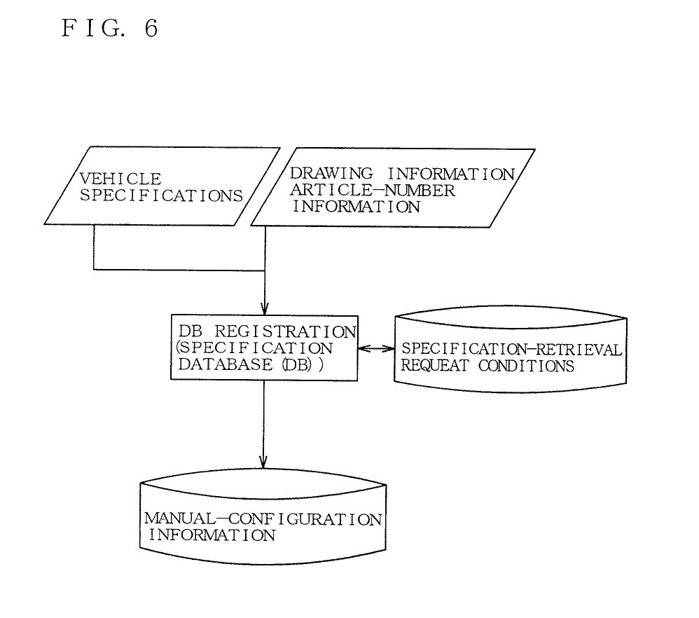

FIG. 6 conceptually shows a processing flow until a manual configuration is determined. In specific, the figure shows the relationship between the above-described specification database and the specification-data retrieval processing that is performed to retrieve specification data stored in the specification database. The outline of the specification-data retrieval processing is as given below. First, as shown in FIG. 5, specification-determination-factor data is pre-associated with the specification data, and the associated data is stored in the specification database. The specification-determination-factor data is used to determine specifications according to information, such as vehicle specifications, drawing information, and article-number information (for example, symbols representing vehicle models). According to a specification-retrieval request condition input by a retrieving person (for example, a manuscript-creating person who uses existing manuscripts), the specification database 25a (FIG. 5) is retrieved. Then, the specification data corresponding to the input specification-retrieval request condition is read out and output. In the configuration shown in FIG. 1 in which retrieval is performed from the terminal 703 through the communication network 702, the specification-retrieval request condition is input from the terminal 703. In response to the input, specification data corresponding to the specification-retrieval request condition is retrieved and read out using the host unit 700, and at least a portion of the specification data is transmitted to the terminal 703 that is the transmission source of the specification-retrieval request condition.

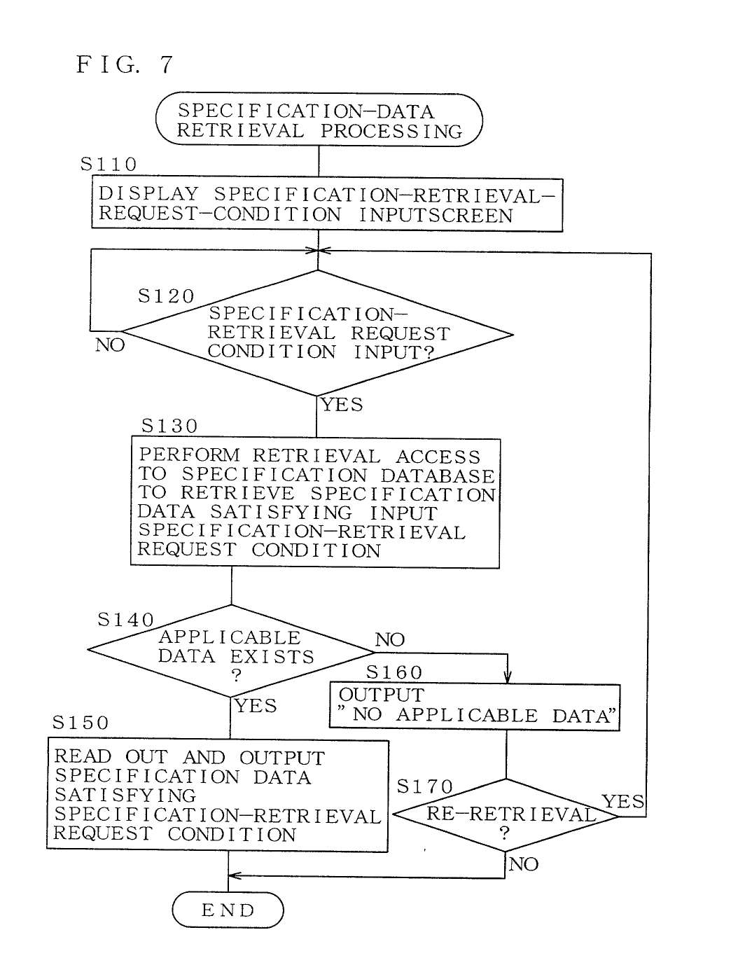

Hereinbelow, a description will be made with reference to a flowchart shown in FIG. 7. First, when the application starts the specification-data retrieval processing, a specification-retrieval request condition input screen is displayed on the monitor 21 (FIG. 2 or 3) (S110). Then, specification-factor determination data is input to specify a specification-retrieval request condition. In the above, the specification-factor determination data represents factors such as the destination and the grade of a product (a vehicle in the present embodiment) that is an object for creating a manual. When the data is thus input, the operation proceeds to YES at S110, and retrieval access is then made to the specification database25a (refer to FIG. 4A) according to the input specification-retrieval request condition. Specifically, retrieval access is performed for specification data matching the input data, such as data representing the destination and the grade (S130). If applicable data exists, processing proceeds to YES at S140, and the specification data satisfying the specification-retrieval request condition is read out and output to the output unit (monitor 21 shown in, for example, FIG. 2) (S15O). If no applicable data exists, the system produces an output indicating that no applicable data is found (S160). The processing may be structured to terminate when applicable data is not found; or alternatively, the processing may be structured to enable re-retrieval. In the processing shown in FIG. 7, when a re-retrieval request is input by a retrieving person, the operation proceeds to YES at S170 and returns to S110 to carry out the re-retrieval request.

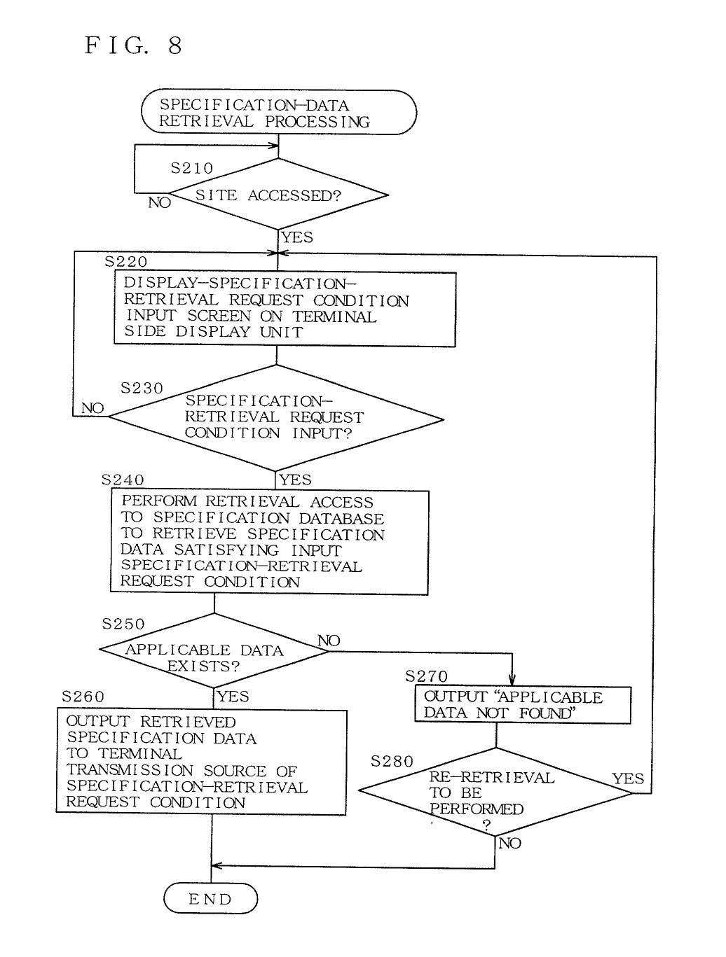

FIG. 8 shows a method of specification-data retrieval processing performed from the terminal 703 connected to the specification database 25a (FIG. 4A) via the communication network 702 by using the network configuration as shown in FIG. 1. Hereinbelow, referring to FIG. 8, the flow of specification-data retrieval processing will be described. A prerequisite site for starting the processing is preliminarily provided on the Internet. When the terminal 703 as shown in FIG. 2 has accessed the information site via the browser 753c (YES at S210), a specification-retrieval request condition input screen is displayed via, for example, the browser 753c, on the display unit (monitor 21) of the terminal 703 (S220). While various types can be conceived for the configuration of specification-retrieval request condition input screen, any type of configuration may be used as long as it enables specification-retrieval request condition to be input from the terminal 703. For example, the screen configuration may be arranged to allow characters to be input to specify the specification-retrieval request condition through, for example, a character-information input box displayed via a browser. Alternatively, the screen configuration may be arranged in which specification-retrieval request conditions are displayed for each type in the form of a listing to allow a selectable input. For example, the screen may be configured such that destinations and grades are displayed in the form of a listing to allow the selection of desired one of each of the destinations and the grades.

After the specification-retrieval request condition has been input, the operation proceeds to YES at S230. Then, at S240, retrieval access is made to the specification database 25a provided in the host unit 700 to retrieve specification data that satisfies the input specification-retrieval request condition. If specification data applicable to the input specification-retrieval request condition exists, the operation proceeds to YES at S250. Then, the retrieved specification data is read out and output to the terminal 703 (S260) that transmitted the specification-retrieval request condition. The output method may be such that, for example, the retrieved data is output to and displayed on the output unit (such as the monitor 21 or the printer 6) of terminal 703. Alternatively, the output method may be arranged such that instead of outputting the data to the output unit, or in addition to outputting the data to the output unit, the data is stored as a data file into the storing device (such as the HDD 753) provided in the terminal 703.

After the manual-configuration information used to form a basic structure of the manual as a skeleton manual has been determined as described above, detailed data is created to provide the contents of the manual. To create the detailed data, the present invention implements a method in which existing manuscript data is preliminarily stored into the manuscript database, and the stored manuscript data can effectively be used when necessary. Hereinbelow, a description will be made regarding the method of using existing manuscript data.

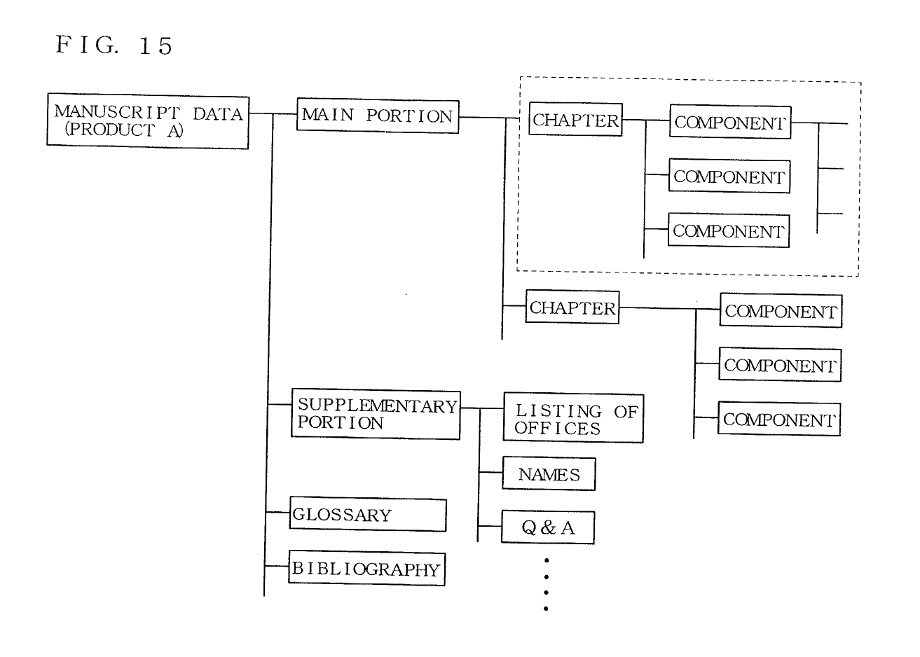

First, the configuration of manuscript data will be described hereafter. FIG. 15 shows the configuration of per-product manuscript data for a manual manuscript of a product A. The per-product manuscript data is structured to include main data, which forms the main portion of the manuscript for the manual, and supplementary-matter data representing supplementary matters regarding the product (the supplementary matters include, for example, location information indicating locations of a head office, other offices, and dealers or the like of a manufacture handling the product; and name information indicating the names of representatives of the manufacturer). In the example shown in FIG. 15, an “office list” is shown, but the manuscript data is not limited thereby. The manuscript data may include various types of “Supplementary-matter Data”, such as general questions and answers (for example, questions frequently made by consumers, and answers thereto) regarding use of products (vehicles in the present embodiment) in the form of Q-and-A information. In this case, a “Q & A” tag may be provided. In addition, the per-product manuscript data may include various types of remarks data. Examples of the remarks data are, for example, diversion-source guide data representing what products are related to diversion source of the per-product manuscript data. In addition, as shown in FIG. 15, the manuscript data may include glossary data to which a “glossary” tag is set. The glossary data can be arranged to represent explanation of terms that appear in the per-product manuscript data. Moreover, the manuscript data may include bibliography data representing descriptions of references and books appearing in the manuscript data (In FIG. 15, a “bibliography” tag is set.).

In addition, in FIG. 15, the main data is separated into multiple items of per-chapter manuscript data. The figure shows an example structure in which the per-chapter manuscript data includes multiple items of component-description data, each of which represents descriptions grouped in units of a component constituting the product. In the example shown in FIG. 12, per-section data is provided in association with the per-section index 103, and the component-description data is provided in association with each of the per-component indices 107 shown in FIG. 13. In this connection, per-relevant-field data may be structured by aggregating items of the component-description data and grouping them in units of a relevant field. For example, as shown in FIG. 12, relevant-component description data (data created by aggregating items of relevant component-description data into data corresponding to, for example, “Keys and doors”) provided to be associated with the per-relevant-component indices 105 may be provided as per-relevant-field data. Alternatively, per-section manuscript data (such as data corresponding to “SECTION 1”) provided to be associated with the per-section index 103 may be provided as per-relevant-field data. In either of the cases, by correlating and aggregating items of component-description data, any type of per-relevant-field data can be structured. Furthermore, the manual can employ various types of configurations. For example, the configuration may be arranged such that one section or a plurality of sections may be integrated as a chapter. Alternatively, the data structure may be arranged not to include a section.

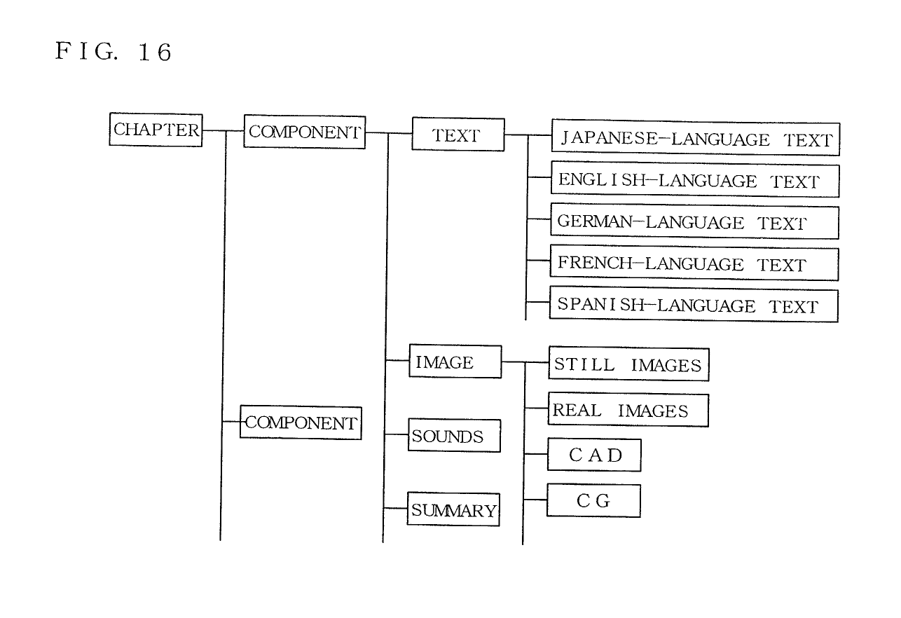

Hereinbelow, referring to FIG. 16, detailed portions of the data structure will be described. The component-description data is structured of character information, and includes text data constituting the text of the manual, and image data, such as still-image data, real or CG motion-image data, or CAD data. In addition, summary data representing summarized component characteristics is provided. In the example shown in FIG. 16, although summary data is provided as data that is different from the text data, a potion of the text data may be set as summary data. The text data includes per-language text data composed in languages of individual nations. Specifically, in addition to Japanese-language text data, there are provided English-language text data, German-language text data, French-language text data, and Spanish-language text data. Languages are not limited to those mentioned above, and any language may be used.

The per-product manuscript data is provided in the hierarchical structures as described above. A group to be provided as an information-handling standard may take any one of the hierarchical structures. Specifically, a group to be read out after data-retrieval may be provided in units of the chapter, the section, or the component. Alternatively, the configuration may be arranged to allow the text data to be read out in units of a paragraph and to allow the image data to be read out in units of a file.

Furthermore, the manuscript data can be divided into a plurality of data elements that individually include attribute data defining the attribute of their own. In the present embodiment, the manuscript data takes the form described in the XML (extensible markup language), data aggregates are expressed in the DTD (document type definition), and an attribute is provided to each of the data aggregates. Specifically, the “chapter” tag is set to manuscript data in each chapter (per-chapter manuscript data), and the data aggregate is thereby furnished with a “chapter” attribute. Similarly, a tag for providing a “component” attribute is provided in the component-description data, thereby setting a “component” tag to the component-description data. The method of setting a tag to a data aggregate to provide it with an attribute is publicly known in, for example, the field of the XML technique, so that detailed description will be omitted herefrom. However, it is to be noted that, as shown in FIG. 16, the attributes such as “text”, “image”, or “summary” is provided to the data; and the data having the aforementioned “text” tag can be added with the per-language attributes, such as “Japanese-language text”, “English-language text”, and “German-language text”. By thus arranging the per-product manuscript data to include multiple types of per-language character data, the data can easily be diverted even for products according to overseas specifications.

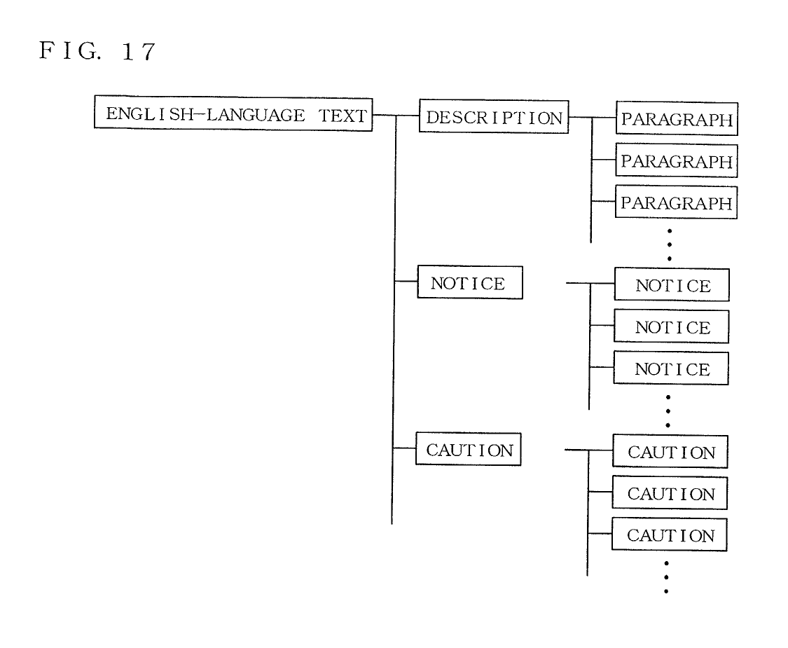

Each per-language character data may be arranged to have a further detailed attribute. FIG. 17 shows a configuration of English-language text data further divided with attributes being provided. Specifically, in each per-language character data, a “description” tag is set to description data composed of descriptions of components and the like, a “notice” tag is set to a notice text for calling attention in the manual, and a “caution” tag is set to a caution text for warning users of the manual. On the other hand, in each image data, a “still image” tag is set to still-image data, a “real image” tag is set to real-image data, a “CG” tag is set to CG data, and a “CAD” tag is set to CAD data. Thereby, the attribute of each of the image data is defined. In addition, the manuscript data has audio data representing narration for data such as the above-described character data or effect sounds for the real-image data and the CG data. Each audio data is furnished with a “sound” tag. The audio data may be coupled with the real-image data, the CG data, or other image data to create composite data. With the composite data, for instance, when an item having a large effect sound as airback is described in a vehicle manual, the type of a sound to be generated and the level of the sound can be sensed, and the actual use condition of the item can be precisely informed.

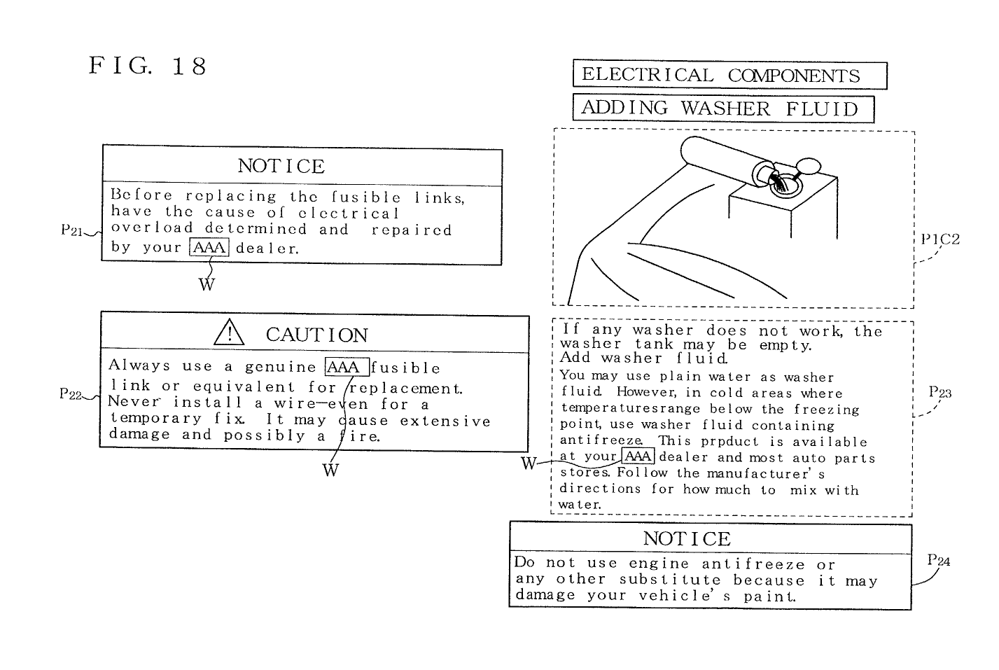

In the manuscript data to which the attributes are added as shown in FIGS. 15 to 17, specifying one of the attributes as a retrieval request condition enables only data corresponding to the specified attribute to be output. For example, when the “Japanese-language text” attribute has been specified as a retrieval request condition, output is carried out for only Japanese-language text data in units of the component. Similarly, when the “still image” attribute has been specified as a retrieval request condition, only still images are retrieved and output. The retrieval range can be reduced through the specification of combined attributes. In addition, as in the English-language text data shown in FIG. 17, the text data includes multiple items of paragraph data as data elements; that is, the data is handled in units of the paragraph. Moreover, the text data can be configured to include the description data composed of descriptions of components and the like, the notice data composed of notice texts intended for cases where products are used, and the caution data composed of caution texts intended for cases where the products are used. FIG. 18 shows an example case in which a part of per-product manuscript data is output to the output unit (such as the monitor 21 or the printer 6). In the figure, paragraphs P21 and P24 each denote text represented by notice data; and paragraphs P22 and P23 denote output texts represented by caution text data and description data, respectively. Image data PIC2 denotes an output text represented by still-image data. However, the structure of the manuscript data is not limited to the aforementioned examples. The data may be structured such that attributes are provided to predetermined character strings such as words and idiomatic phrases, and the character strings furnished with the attributes (the character string hereinbelow will alternatively be referred to as an “attribute-included character string”) are retrieved in units of the attribute. For example, suppose FIG. 18 represents a manual of a vehicle model AAA. In this case, for example, a “vehicle model name” tag is set to word data (word W) in a portion representing the vehicle model name, thereby enabling a corresponding attribute to be provided thereto. According to this arrangement, for example, when the manuscript data is applied to a manual of a different vehicle model, the portions to which the “vehicle model name” tag has been set can be converted in batch to potions each having a different vehicle model name. Thereby, the efficiency can be increased.

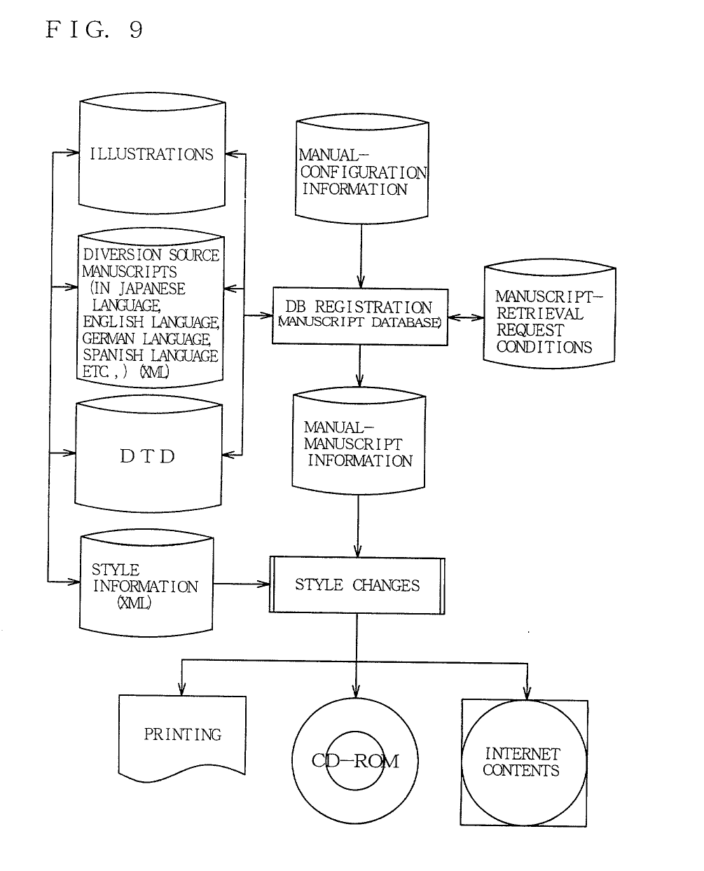

FIG. 9 conceptually shows a flow of investigation and determination regarding a manual manuscript. The flow is outlined hereinbelow. As a prerequisite for manual-manuscript retrieval processing, image data such as illustrations, diversion-source manuscript data (such as text data and summary data) are stored in the manuscript database 25b (refer to FIG. 4A). In this case, such data is stored so as to be grouped into the per-group data, as described above. In the above, “so as to be grouped into the per-group data” implies that the manuscript data can be handled in units of a predetermined data aggregate, and any attribute may be used as a standard for grouping the data. According to the input of manuscript-retrieval request condition for retrieving per-group description data, retrieval-readout is performed from the manuscript database for per-group description data that satisfies the input manuscript-retrieval request condition. In addition, at least a part of the read out per-group description data is output to the display unit such as the monitor. Since the manuscript data is stored in the manuscript database either in the XML format or in a file format that can easily be converted in the XML format, style changes and the like can be easily performed. In addition, the manuscript data can easily be used as data of various types, such data for printing, a CD-ROM, and Internet contents.

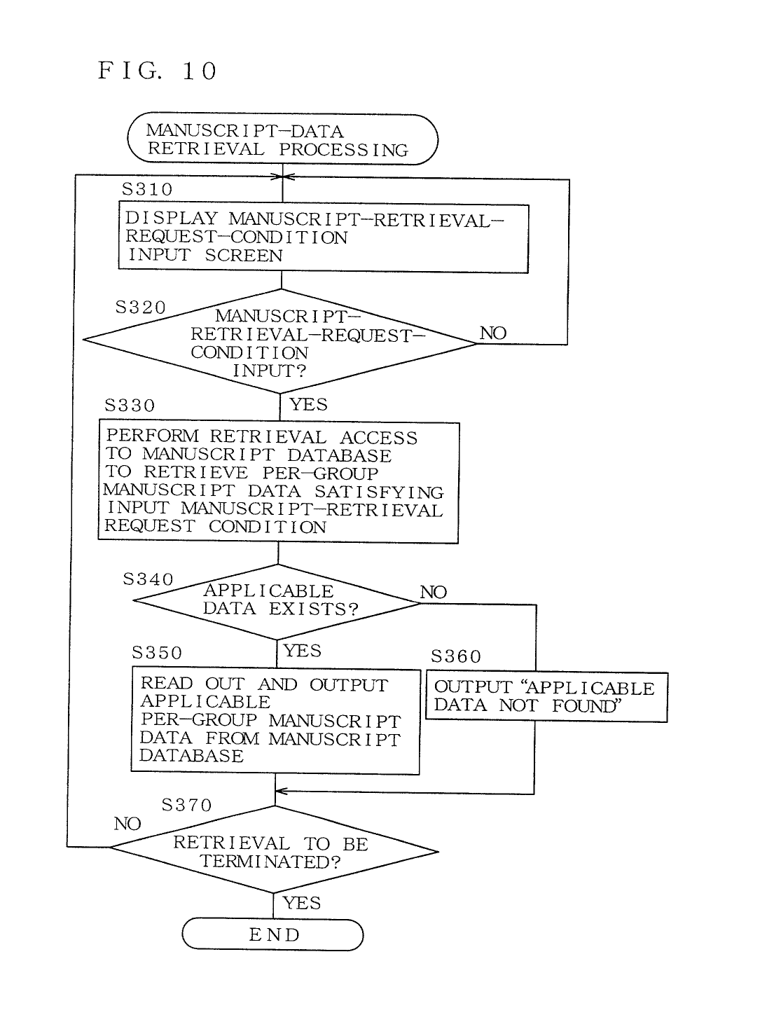

Hereinbelow, referring to FIG. 10, a description will be made regarding a flow of retrieval processing for manuscript data that will be obtained through retrieval performed by a manual-creating person or the like. First, to start the retrieval processing, a manuscript-retrieval request condition input screen is displayed on the display unit (monitor 21) (S310). Then, after manuscript-retrieval request condition is input through the aforementioned manuscript-retrieval request condition input screen, the operation proceeds to YES at S320, and retrieval access is then made to the manuscript database 25b for per-group manuscript data satisfying the input manuscript-retrieval request condition (S330). For example, in the case where the component-description data is arranged to be per-group manuscript data as shown in FIG. 4, according to a manuscript-retrieval request condition in which a component is specified, retrieval is performed for component-description data corresponding to the specified component. In the retrieval, if applicable data exists, processing proceeds to YES at S340, and the applicable per-group manuscript data is read out of the manuscript database 25b (shown in FIG. 4A), and the data is output to the monitor 21 (shown in FIG. 2 or 3) (S350). If no applicable data exists at S340, the monitor 21 (shown in FIG. 2 or 3) displays an output indicating that “applicable data is not found” (S360). In either of the cases, upon completion of the processing of responding to the input manuscript-retrieval request condition, the system inquires the retrieving person about whether or not retrieval is still desired for different per-group description data (in a converse way of saying, the system inquires the retrieving person about whether or not to terminate the retrieval processing) at S370. If a response is issued to terminate the retrieval, the manuscript-data retrieval processing terminates. If a response is issued to continue the retrieval, the operation proceeds to NO at S370, and the system iterates steps S310 to S370. The flowchart shown in FIG. 10 can be applied either to processing performed with the communication network shown in FIGS. 1 and 2 or to processing performed with the single computer shown in FIG. 3.

Depending on the manuscript-retrieval request condition, various retrieval methods can be applied. For example, the method may be arranged such that an input unit is used to specify one of the components constituting a product, and component-description data corresponding to the specified component is thereby retrieved and read out. In this case, the component-description data is handled as per-group description data. The method of inputting the manuscript-retrieval request condition (that is, inputting a specified component) may be arranged such that image data of a plurality of components are list-displayed using thumbnail images. Then, according to the manuscript-retrieval request condition in which the image data of one of the components is specified, retrieval-readout is performed for component-description data corresponding to the specified image data. In the case, however, items to be list-displayed are not limited to still-image. The items may be CG-image data, CAD-image data, or real-image. Alternatively, the method may be arranged such that instead of list-displaying the image data, component names are list-displayed. Still alternatively, the component name may be directly input in characters.

In addition, the method may be arranged such that items of component-description data are aggregated in units of a relative field, and are grouped in that state. Then, according to the manuscript-retrieval request condition in which one of the relative fields is specified, retrieval-readout is performed for per-relevant-field data corresponding to the specified relative field. In this case, the per-relevant-field data is handled as per-group description data. As described above, in the case where items of the relevant-component description data that are provided to be associated with the per-relevant-component indices 105 (refer to FIG. 12) are handled as per-relevant field data, according to the condition in which one of the relevant components (such as “Keys and doors”) is specified, retrieval is performed for per-relevant-component data corresponding to the specified relevant component. Moreover, in a case where items of the per-section manuscript data that are provided to be associated with the per-section indices103 (refer to FIG. 12) are handled as per-relevant field data, according to the condition in which information (for example, a part or the entirety of a title of the section) for specifying one of the sections is specified, per-section manuscript data corresponding to the specification can be invoked. In either of the cases, as shown in FIG. 14, the index and the per-group description data are displayed on the screen in the form corresponding to each other; and as described above, correction, addition, and determination of the manuscript are carried out through the screen.

Furthermore, the configuration may be arranged to enable retrieval-character-string data, such as a keyword or a key sentence, to be input as a manuscript-retrieval request condition. In this case, retrieval-readout is performed for per-group description data composed to include a character string that is identical or similar to the input retrieval-character-string data. For example, when the keyword “REMOTE CONTROL” is input, the system outputs pergroup manuscript data including the keyword (keyword K in FIG. 14) “REMOTE CONTROL” in the manuscript data. The unit of the output may be, for example, either the entirety of component-description data as shown in FIG. 14 or a paragraph like a paragraphP 12 shown in FIG. 14 including the input keyword.

Still furthermore, the configuration includes summary data representing a summary of component characteristics in units of component-description data. When retrieval-character-string data is input as a manuscript-retrieval request condition, according to the input retrieval-character-string data, retrieval access is performed for the summary data of the individual component-description data. That is, retrieval-readout can be performed for component-description data including summary data composed to include a character string that is identical or similar to the input retrieval-character-string data. The summary data may be composed of character data less than component-description data in amount. In addition, the summary data may be structured to include retrieval-character string aggregates formed of a plurality of aggregates of character strings such as keywords and key-sentences regarding components to be associated with the component-description data. With this data structure, the configuration can be arranged such that when retrieval-character-string data as described above has been input, only corresponding summary data is retrieved. This configuration enables the time involved in the retrieval to be significantly reduced. Effects equivalent to those in the retrieval of the summary data can be obtained even in the configuration in which the above-described retrieval-character string aggregates are retrieved according to retrieval-character-string data that has been input.

Furthermore, the summary data can be arranged to be character data composed mainly in a second language that is different from a language^{(*)} used as a standard for text data in the manuscript data (*: hereinafter, the language is alternatively referred to as a manuscript-data standard language). Still furthermore, the configuration may be arranged such that according to an input of second-language retrieval-character-string data, readout is performed for per-group description data corresponding to summary data composed to include a character string that is identical or similar to the input retrieval-character-string data. As a practical example, the configuration may be arranged such that text data can be made to be English-language text data mainly composed in the English language, and summary data can be made to be Japanese-language summary data mainly composed in the Japanese language. For an ordinary Japanese retrieving person, when text data is composed in a language other than the Japanese language, a retrieval character string needs to be translated into the language used in the text data to be input. This can cause problems in time and technology. However, even when the text data is composed in a language that is different from that a retrieving person uses, according to the configuration where summary data is preserved in the different language, retrieval can easily be achieved.

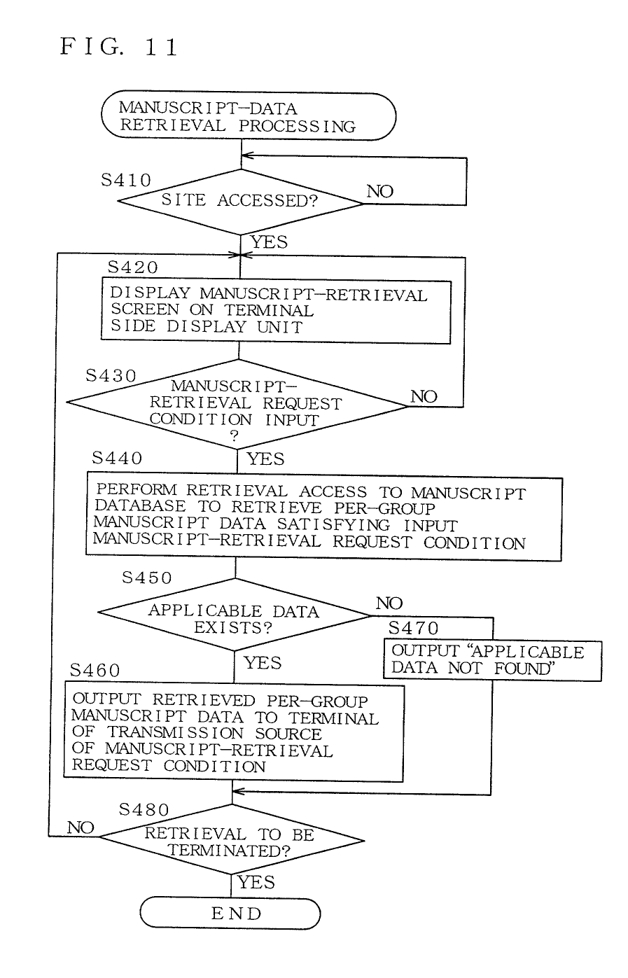

FIG. 11 shows a case in which the above-described manuscript-data retrieval processing is performed through a communication network such as the Internet. Similarly to the above-described specification-data retrieval processing, the present manuscript-data retrieval processing is performed through a communication network such as the Internet. First, when the site is accessed (YES at S410), a manuscript-retrieval screen is displayed on the monitor 21 of the terminal 703 (S420). The manuscript database (refer to FIG. 4A) is provided in the host unit 700 as shown in FIG. 1. When a manuscript-retrieval request condition (such as the above-described data specifying a component or retrieval-character-string data) is input using the terminal 703 connected to the host unit 700 via a communication network such as the Internet, processing proceeds to YES at S430. Then, the system retrieves and reads out per-group description data satisfying the input manuscript-retrieval request condition, and sends at least a part of the read out per-group description data to the terminal 703 that is the transmission source of the manuscript-retrieval request condition. The method of outputting the per-group manuscript data may be arranged such that data as shown in FIG. 14 or 18 is displayed on a browser screen in the monitor 21 provided in the terminal 703. Alternatively, the output method may be arranged such that the manuscript data as mentioned above is transmitted in the XML format to the terminal 703, and the data is directly stored into a storage medium such as the HDD provided in the terminal 703. In addition, the arrangement may be made such that access is charged to the terminal side either based on manuscript-data transmission performed to the terminal 703 or on the basis of a transmission request made from the terminal 703 to the host unit 700 for retrieval of manuscript data. As above, the description has been made with reference to the case in which the manuscript data is output from the host unit 700 to the terminal 703. However, the arrangement may be made such that manuscript data in, for example, the XML format, is transmitted from the terminal 703 to the host unit 700; and in response to the transmission, the manuscript data is stored in the manuscript database 25b (refer to FIG. 4A) provided in the host unit 700. Specifically, the arrangement allows the storage/registration of manuscript data transmitted from the terminal side.

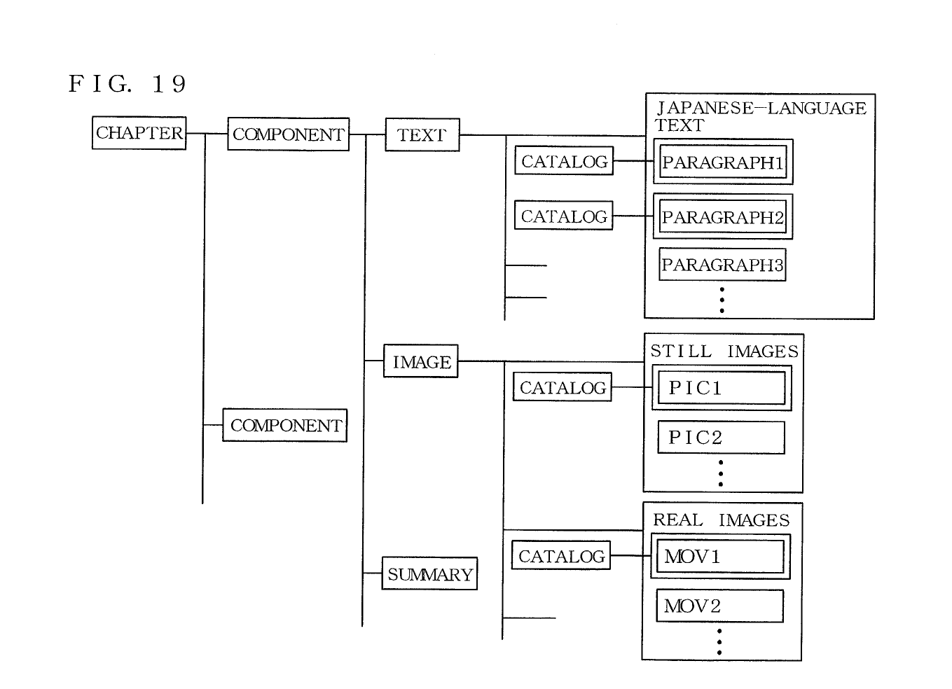

In addition, the arrangement may be made such that a part of stored per-product manuscript data is provided as a catalog or a simplified manual through the Web. The arrangement may also be made in which an attribute to be used for simplified-description-dedicated manuscript data is set to at least a part of data elements constituting per-product manuscript data, and the data element to which the attribute has been set is output as simplified-description-dedicated manuscript data for documents such as a catalog and a simplified manual. In this data structure, in the part of data elements in the per-product manuscript data, there is formed the simplified-description-dedicated manuscript data having a data amount less than that of the per-product manuscript data. In more specific, as shown in FIG. 19, for example, a “catalog” tag is preliminarily set in a part of data elements of each text data and in a part of data elements of each image data. In this case, the individual parts are intended for the simplified-description-dedicated manuscript data, as described above. In this structure of the per-product manuscript data, when retrieval access is performed only for the data element including the “catalog” tag, retrieval is achieved for paragraph data, still-image data, motion-image data, and the like that have the “catalog” tag. In this case, the arrangement can be made such that in response to information input from the terminal 703 to request for the simplified-description-dedicated manuscript data, the requested simplified-description-dedicated manuscript data is output to the monitor 21 of the terminal 703 that has made the request through a browser screen. In addition, manuscript data may be arranged to be handled on the Internet by using the VRML (virtual reality modeling language) of a language specification for describing 3D-CGs. Using the aforementioned language enables the synchronous representation of sounds, motion images, and text in addition to three-dimensional spatial representations, such as coordinate data, polygon-represented shape data, light sources, viewpoint information, and texture. In addition, using the VRML enables, for example, motions of various types and interactivity, to be provided to an intrascene object.

Furthermore, the data structure may be arranged such that an attribute for a manuscript for a repair manual used for repair or failure diagnosis is provided in a part of a plurality of data elements in the per-product manuscript data. With this data structure, only data elements to which the attribute is provided are output as failure-diagnosis-dedicated data. For example, the potions “NOTICE” and “CAUTION” shown in FIG. 18 may be used for the failure-diagnosis-dedicated data. However, there are no specific limitations thereto, and various manuscripts (such as data representing descriptions that are to be referenced when a problem has occurred) may be used for the failure-diagnosis-dedicated data. With the above-described attribute being provided, information that serves as a failure-diagnosis manual and a repair manual can be provided through the Web. With combined retrieval conditions of the above-described failure-diagnosis-dedicated data and a different retrieval condition, failure-diagnosis data conforming to an intended object can be obtained. The failure-diagnosis-dedicated data as described above may be arranged to be technical advice data corresponding to cases of problem occurrence, such as “When the engine does not start” and “When a xxx lamp has turned on”.

Still furthermore, any one of the above-described manual creation methods allows functions described below to be added as tutorial support tools. For example, a function may be added that serves such that when retrieval input is carried out with the system, a retrieving person is prompted to input identification information (such as an ID, a password, and other personal information) for identifying the retrieving person. According to the function, for example, when the retrieving person has retrieved per-group manuscript data, the system stores data representing the instance of the retrieval achieved by the retrieving person for the per-group manuscript data. For example, the identification information of the retrieving person and the retrieved per-group manuscript data can be associated together, and are stored in the associated state. The storing method may be arranged to store per-ID data representing identifications of manuscripts retrieved by the retrieving person having the corresponding ID, and the retrieval amount of each of the manuscripts. The data stored in the above manner enables tendencies of the retrieval performed by the retrieving person to be known. Consequently, the function effectively works, for example, in providing a guide for retrieving persons to uniformly read product description data, and in knowing retrieval tendencies for individual retrieving persons.

While the preferred embodiments of the present invention have been described as above, the invention is not limited by the embodiments. It should be understood that without being limited by wordings in the appended claims, and various changes, modifications, and improvements may be made to the extent that the embodiments are replaced by their equivalents unless otherwise the changes, modifications, and improvements depart from the spirit and scope of the invention.

What is claimed is:

1. A component-description-manual creation support method, wherein for creation of a component description manual such as an instruction manual or a repair manual for individual components of a unit product formed as an assembly of many components for an automobile or the like, text, drawing, image, and other component-description data for each of the components in a component-description-manual created in the past is stored in storing means in a form including text data that constitutes text of the component description manual, and summary data that summarizes characteristics of the individual components, and in a retrievable form including retrieval terms with which said individual component-description data can individually be retrieved; and when newly creating a component description manual of a specific component, according to an input of retrieval terms such as an article number, a name, a characteristic, and the like of a component that is similar to or identical to the specific component, only summary data is retrieved from an aggregate of said component-description data stored, and description data regarding the specific component corresponding to the summary data is read out of said storing means, wherein:
when applicable component-description data has been retrieved, the component-description data is copied by data-creating means, and the component-description data is either diverted as copied or is appropriately edited, thereby making said component-description data to be creation-object component-description data;
when no applicable component-description data has been retrieved, component-description data of the specific component is newly written, thereby making said component-description data to be creation-object component-description data; and
either said newly written component-description data or both said newly written component-description data and said edited component-description data are stored in said storing means in said retrievable form as component-description data for creation of a subsequent component description manual so as to be accumulatively stored as a database.

2. A component-description-manual creation support method, wherein for creation of a component description manual such as an instruction manual or a repair manual for individual components of a unit product formed as an assembly of many components for an automobile or the like, text, drawing, image, and other component-description data for each of the components in a component description manual created in the past is stored in storing means in a form including text data that constitutes text of the component description manual and that is composed in a first language, and summary data that summarizes characteristics of the component and that is composed in a second language which is different from the language used for said text data, and in a retrievable form including retrieval terms with which said component-description data can individually be retrieved; and
when newly creating a component description manual of a specific component, according to an input retrieval terms in said second language, such as an article number, a name, a characteristic, and the like of a component that is similar to or identical to the specific component, only summary data is retrieved from an aggregate of said component-description data stored, and component-description data in first language regarding the specific component corresponding to the summary data is read out of said storing means, wherein:
when applicable component-description data in said first language has been retrieved, the component-description data in said first language is copied by data-creating means, and the component-description data is either diverted as copied or is appropriately edited, thereby making said component-description data to be creation-object component-description data;
when no applicable component-description data has been retrieved, component-description data of the specific component is newly written, thereby making said component-description data to be creation-object component-description data; and
in said newly written component-description data and said edited component-description data, at least said newly written component-description datais stored in said storing means in said retrievable form as component-description data for creation of a subsequent component description manual so as to be accumulatively stored as a database.

3. The component-description-manual creation support method as defined in one of claims 1 and 2, wherein:
said component-description data is grouped in units of a product;
said component-description data grouped in units of a product is structured to comprise a plurality of data elements;
a part of said plurality of data elements comprises an attribute for a failure-diagnosis-dedicated manuscript used for repair or failure diagnosis; and
only the data element to which said attribute for the failure-diagnosis-dedicated manuscript can be output as failure-diagnosis-dedicated data from said component-description data stored.

4. The component-description-manual creation support method as defined in one of claims 1 to 3, wherein a virtual reality modeling language (VRML) is used as a language specification for said component-description data.

5. A computer-readable recording medium comprising a program recorded therein for executing the component-description-manual creation support method as defined in one of claims 1 to 4, wherein said program executes steps in said component-description-manual creation support method with a computer.

6. A component-description-manual creation support system, comprising:
storing means functioning such that for creation of a component description manual such as an instruction manual or a repair manual for individual components of a unit product formed as an assembly of many components for an automobile or the like, said storing means stores text, drawing, image, and other component-description data for each of the components in a component description manual in the past in a form including text data that constitutes text of the component description manual, and summary data that summarizes characteristics of the individual components, and in a retrievable form including retrieval terms with which said individual component-description data can individually be retrieved;
retrieval means functioning such that when newly creating a component description manual of a specific component, according to an input retrieval terms such as an article number, a name, a characteristic, and the like of a component that is similar to or identical to the specific component, only summary data is retrieved from an aggregate of said component-description data stored, and description data regarding the specific component corresponding to the summary data is read out of said storing means;
data-creating means functioning such that when applicable component-description data has been retrieved, the component-description data is copied, and the component-description data is either diverted as copied or is appropriately edited, thereby making said component-description data to be creation-object component-description data, and when no applicable component-description data has been retrieved, component-description data of the specific component is newly written, thereby making said component-description data to be creation-object component-description data; and
data-accumulating means for storing either said newly written component-description data or both said newly written component-description data and said edited component-description data are stored in said retrievable form as component-description data for creation of a subsequent component description manual so as to be accumulatively stored as a database.

7. A component-description-manual creation support system, comprising:
storing means functioning such that for creation of a component description manual such as an instruction manual or a repair manual for individual components of a unit product formed as an assembly of many components for an automobile or the like, said storing means stores text, drawing, image, and other component-description data for each of the components in a component description manual created in the past in a form including text data that constitutes text of the component description manual and that is composed in a first language, and summary data that summarizes characteristics of the component and that is composed in a second language which is different from the language used for said text data, and in a retrievable form including retrieval terms with which said component-description data can individually be retrieved;
retrieval means functioning such that when newly creating a component description manual of a specific component, according to an input of retrieval terms in said second language, such as an article number, a name, a characteristic, and the like of a component that is similar to or identical to the specific component, said retrieval means retrieves only summary data from an aggregate of said component-description data stored, and description data in first language regarding the specific component corresponding to the summary data is read out of said storing means;
data-creating means functioning such that when applicable component-description data in said first language has been retrieved, the component-description data in said first language is copied, and the component-description data is either diverted as copied or is appropriately edited, thereby making said component-description data to be creation-object component-description data, and when no applicable component-description data has been retrieved, component-description data of the specific component is newly written, thereby making said component-description data to be creation-object component-description data; and
data-accumulating means functioning for storing at least said newly written component-description data selectively from said newly written component-description data and said edited component-description data in said retrievable form as component-description data for creation of a subsequent component description manual so as to be accumulatively stored as a database.
